(19) United States
(12) Patent Application Publication
(10) Pub. No.: US 2025/0304799 A1
(43) Pub. Date: Oct. 2, 2025

(54) USE OF RESIN OR ANTIFOULING RESIN ON UNDERWATER STRUCTURES FOR EASIER CLEAN UP OF BIO-FOULING THEREON AND/OR TO LIMIT BIO-FOULING THAT OCCURS

(71) Applicant: Eco Finish, LLC, Warminster, PA (US)

(72) Inventor: Joseph Solona, Doylestown, PA (US)

(21) Appl. No.: 19/217,178

(22) Filed: May 23, 2025

Related U.S. Application Data
(60) Provisional application No. 63/571,227, filed on Mar. 28, 2024.

(51) Int. Cl. C09D 5/16; B05D 1/02; B05D 1/32; B05D 7/00; C08K 3/08; C09D 7/41; C09D 7/61; C09D 7/80; C09D 123/06; C09D 163/00

(52) U.S. Cl. CPC C09D 5/1618; B05D 1/02; B05D 1/32; B05D 7/587; B05D 7/588; C08K 3/08; C09D 7/41; C09D 7/61; C09D 7/80; C09D 123/06; B05D 2504/00; B05D 2507/01; B05D 2601/28; C08K 2003/0806; C08K 2003/085; C09D 163/00

(57) ABSTRACT

A resin applied to underwater structures to enable biofouling growing thereon to be removed therefrom much easier than biofouling growing directly on the underwater structure. Adding antifungal properties to the resin enables the resin to prevent, or limit, the growth of biofouling thereon. The antifungal properties are provided by at least some subset of antifungal agents (e.g., copper) and antimicrobial agents (e.g., silver). The agents are mixed with plastic (e.g., polyethylene), melted, extruded into a solid form and then processed into an antifouling resin where the antifouling agent is embedded and integrated in the resin prior to application. The antifouling resin presents its antifouling properties immediately upon application and does not require gradual degradation to expose the active antifouling agents. The antifouling resin is thermal sprayed onto the underwater structure (an initial layer may be thermal sprayed onto an epoxy layer prior to curing to merge the two layers).

### PRIORITY

This application claims the benefit under 35 USC § 119 of U.S. Provisional Application 63/571,227 filed on Mar. 28, 2024. Application 63/571,227 is herein incorporated by reference in their entirety.

### BACKGROUND

Biofouling, or marine growth, on underwater structures is a pervasive issue with far reaching implications for the integrity and functionality of the underwater structures and environmental impact on the ocean. Key challenges posed by marine growth include, but are not limited to, structural integrity degradation, accelerated corrosion, reduced hydrodynamic efficiency, elevated maintenance and operational costs, environmental hazards, impairment of functionality, aesthetic deterioration and spread of invasive species.

The accumulation of organisms like barnacles and algae significantly increases the weight borne by underwater structures, leading to undue stress and potential mechanical failure which may degrade the structural integrity of the underwater structure. Certain marine organisms can exacerbate the corrosion process of construction materials (e.g., accelerate the corrosion thereof), particularly metals, thereby weakening the structures and diminishing their lifespan.

In the case of mobile underwater entities, such as ship hulls and turbines, biofouling creates a roughened surface profile, leading to increased drag and a consequent decrease in operational efficiency, manifested in higher fuel requirements and reduced speed or energy output (reduces the hydrodynamic efficiency of the vessel). Mobile underwater structures also pose the risk of transporting biofouling organisms, including invasive species, across various marine ecosystems, thereby threatening the ecological balance in these areas.

For underwater structures equipped with sensors and operational mechanisms, such as oil rigs and scientific monitoring apparatus, biofouling can obstruct their effective functioning, leading to compromised performance and data integrity. For structures where visual appeal is a consideration, the presence of marine growth can be visually unappealing, detracting from the aesthetic value thereof.

The biofouling of the underwater structures necessitates frequent and intensive maintenance procedures to mitigate the effects of biofouling which represents a significant economic burden, encompassing both direct remediation costs and indirect expenses related to operational downtime (elevates maintenance and operational costs). The maintenance procedures may include removing the underwater structures from the water or evacuating the water from around the structure so that the underwater structure can be cleaned. The cleaning may entail blasting, scrapping and/or sanding the biofouling off of the structure. The cleaning may remove any coating provided on the structure and possibly damage the structure and thus require fixing the structure and reapplying the coating.

Conventional antifouling strategies may entail utilizing roll-on or sprayed paint coatings containing cuprous oxide to inhibit marine growth on underwater structures. A critical drawback of these conventional coatings is their reliance on the gradual erosion of the paint layer for the effective release of the active antifungal agent, cuprous oxide. The necessity for the coating to erode to release the antifungal agent inherently implies a finite lifespan for each application. As a result, frequent reapplication is required to maintain effective biofouling prevention. This regular maintenance not only increases direct costs associated with the purchase and application of the coating but also incurs indirect expenses due to operational downtime during reapplication procedures.

The erosion of the paint layer introduces toxic substances into the marine ecosystem, potentially causing adverse environmental effects. Furthermore, the erosion process leads to the continuous release of cuprous oxide into the marine environment. While effective in inhibiting marine growth, cuprous oxide is a known biocide with potential toxic effects on the oceanic ecosystem. Its gradual release into the water can adversely affect non-target marine organisms, contributing to ecological imbalance and potential environmental harm.

What is needed is a coating for underwater structures that enables biofouling to be easily removed with limited impact to the coating or the underlying structure. Furthermore, what is needed is a coating that provides antifouling properties and addresses the significant limitations inherent in conventional antifouling strategies using cuprous oxide-based coatings. A more sustainable, cost-effective, and environmentally friendly solution for removing biofouling when it occurs and limiting biofouling on underwater structures and ensuring the structural integrity, operational efficiency, and ecological compliance thereof.

### BRIEF DESCRIPTION OF THE FIGURES

Further features and advantages of the present invention, as well as the structure and operation of various embodiments of the present invention, will become apparent and more readily appreciated from the following description of the preferred embodiments, taken in conjunction with the accompanying drawings of which:

FIG. 1 illustrates a block diagram of an exemplary method of preparing an underwater structure, according to one embodiment.

FIG. 2 illustrates a block diagram of an exemplary method of applying a resin finish to an underwater structure, according to one embodiment.

FIG. 3 illustrates a block diagram of an exemplary layering method to create a multi-colored resin finish on an underwater structure, according to one embodiment.

FIG. 4 illustrates an exemplary process for creating an antifouling resin finish to prevent marine growth on underwater structures, according to one embodiment.

### DETAILED DESCRIPTION

The application of a resin to underwater structures (substrates) may enable biofouling that grows thereon to be removed without requiring the substrate to be removed from the water, without any equipment that could damage the resin or the underlying substrate (e.g., media blaster), and/or without any additives (e.g., chemicals). The resin can be applied to any substrate that remains under water or in the water for long periods of time where biofouling could be an issue. The substrate may be located in salt water (e.g., ocean) or fresh water (e.g., lake). The substrates may be items that permanently remain in the water (e.g., docks, sea walls, bridges) or may be items that may be removed therefrom (e.g., boats). The substrates may be various materials including, but not limited to, fiberglass, concrete, aluminum, steel, wood, composites or other materials capable of performing a function underwater. The use of the resin simplifies the removal of the biofouling, limits damage to the resin as well as the underlying substrate, and accordingly reduces the cost and time associated therewith. Furthermore, the resin may provide better protection against the elements (e.g., ultraviolet light, water).

The resin may come in the form of powder that can be melted and applied to the substrate. The resin may come in various colors and may be ultraviolet resistant so that the color does not fade, for example due to the ultraviolet rays of the sun, for a fairly long time. The resin may be designed to melt and become a liquid at a fairly low temperature (e.g., less than approximately 120 degrees Celsius) so that excess heat is not required for application. The resin may also be designed to have a high melt flow, which means that it will lay flat after application in a relatively short amount of time. The resin can be applied to the substrates before they are located in the water (e.g., before a boat is placed in the water, before a piling is installed in the water). Alternatively, the resin may be applied to the substrate after the substrate has been located in the water. The substrate would need to be removed, or isolated, from the water (e.g., boat removed from water, water removed from around piling). After the substrate was removed from the water it would need to cleaned and dried prior to the application of the resin.

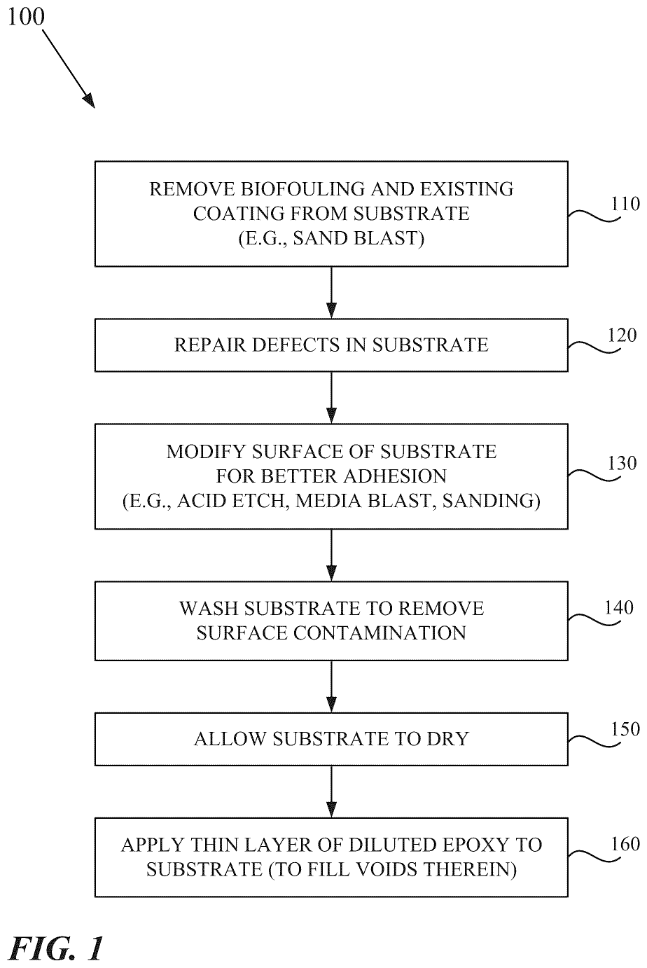

FIG. 1 illustrates a block diagram of an exemplary method of preparing an underwater structure (substrate) 100. If the substrate is located in the water it either needs to be removed from the water or the water needs to be isolated (e.g., removed, pulled back) from the substrate. If the substrate has been in the water it is possible that the substrate contains biofouling. Accordingly, the substrate should be cleaned in order to remove the biofouling and any existing coating that was located on the substrate to expose a clean substrate 110. The biofouling may be difficult to remove and may require, for example, media (e.g., sand) blasting. If the substrate had not been located in the water but had a coating (e.g., paint) provided thereon, the coating should be removed. If the substrate contains any defects (e.g., cracks, voids, holes, extrusions) the substrate should be repaired 120. The repairs may include patching voids and/or sanding extrusions. After the surface is repaired, the substrate should be modified to remove any contaminations that may still be present and to provide a rough and/or textured surface to enable better adhesion thereto 130. The modification may be provided via, for example, an acid etch, a media blast, and/or sanding. According to one embodiment, the surface should be modified so that it has a texture similar to approximately 80-120 grit sandpaper.

The surface of the substrate is then washed to remove chemicals, dirt, oil and any other surface contaminations as well as any residual acid 140. The surface may be washed using a power washer. According to one embodiment, a tri-sodium phosphate (TSP) or an appropriate alternative may be used with the power washing. The substrate is then allowed to completely dry 150. Any number of means may be used to expedite the drying of the surface, including using heat from thermal sprayers used to apply the resin (discussed in more detail later) or fans to assist in the flow and movement of air over the surface. A thin layer of diluted epoxy may be applied to the surface to, for example, fill any minor voids that may be contained therein 160. The diluted epoxy may be an approximate 50/50 combination of epoxy and a Xylene solvent. The diluted epoxy is a low viscous epoxy that may seep deep into pores creating a deeper bond and will help eliminate pin holes in the resin when it is applied. Depending on the porosity of the surface a second thin layer of the diluted epoxy may be applied.

The preparation of the underwater structure is not limited to the steps discussed above. Rather, steps may be added, steps may be removed, the order of steps may be changed, steps may be combined, steps may be split apart, and/or steps may be modified without departing from the current scope. Modifications to the process may be made based on the type of substrate that is being prepared as the materials it is made of, its size and shape, and the location where the preparation occurs may all be factors in the exact manner the process is conducted.

Once the substrate is prepared, the resin may be applied thereto. Rather than apply the resin directly to the substrate the resin may be applied to an epoxy layer that is applied to the substrate to provide better adhesion. According to one embodiment, the resin may be applied once the epoxy becomes tacky and before it is cured. The application of the resin while the epoxy is still tacky (before it is hard) causes the resin and the epoxy to blend into a single layer. The layer of resin applied at this point may be a thin layer. An additional layer of resin may be applied after the epoxy and the first layer of resin have fully cured. According to one embodiment, after the second layer of resin has cured an additional layer may be applied to provide designs, markings or the like. The designs and/or markings may be produced with tape and/or stencils and the next layer may be applied to the non-covered areas to provide the desired look.

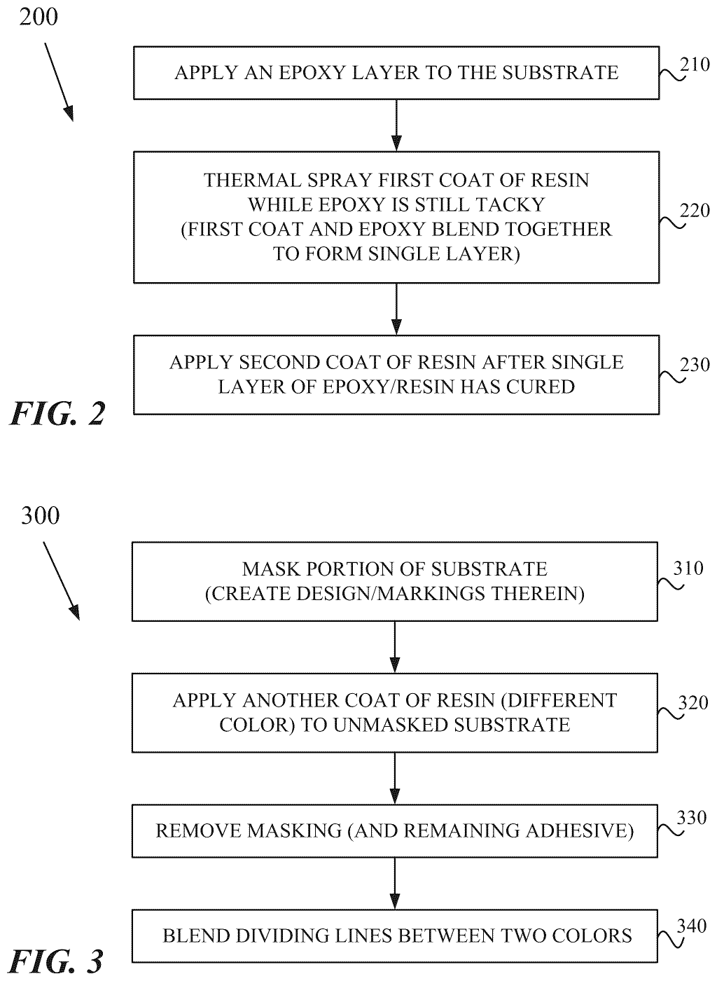

FIG. 2 illustrates a block diagram of an exemplary method of applying a resin finish to an underwater structure (substrate) 200. After preparation of the substrate 100 has occurred, a layer of epoxy is applied to the substrate 210. The epoxy may be a solvent free epoxy resin. The epoxy may be a two-part epoxy that is mixed (with for example a paddle mixer for approximately two minutes) prior to application. The epoxy may be applied using a roller. According to one embodiment, the epoxy should be applied with a thin nap roller as a thick nap roller may result in bubbled and/or uneven application.

Once the epoxy begins to become tacky (before it is cured) a first coat of resin is applied to the substrate using a thermal sprayer (the first coat of resin is thermally sprayed onto the tacky epoxy on the substrate) 220. The application (thermal spraying) of the resin to the uncured epoxy layer which in effect causes the two layers to merge (the resin integrates with the epoxy). The thermal sprayer includes a gas source (e.g., propane) that is ignited to create a flame that is blown out of the thermal sprayer. The thermal sprayer also includes a housing for holding the resin and feeding the resin into the flame as it blows the resin out of the thermal sprayer. The flame melts the resin as the resin passes throw the flame and/or after the resin has been blown out of the thermal sprayer and is on the surface. The resin may also function as fuel for the flame and increase the size of the flame as the resin passes therethrough. If the resin is not fully melted as it is blown out of the thermal sprayer and adhered to the substrate it can be further melted by heating the substrate with the thermal sprayer.

The resin may be designed to melt and become a liquid at a fairly low temperature (e.g., less than approximately 120 degrees Celsius). Accordingly, the thermal sprayer may be operated at approximately 120° C.

The first coat of resin may be lightly applied. The resin may be lightly applied by setting the thermal sprayer to a low feed rate so that a small amount of melted resin is blown onto the surface at a time. The resin may have a high melt flow so that it lays flat after application in a relatively short amount of time. The first coat of resin may be a first color (or color mix). The color of the first coat is not limited to any specific color. The color may be selected based on any number of parameters including, but not limited to, the type of substrate, location of the substrate, and who owns or uses the substrate. The application of the first coat may lightly coat the substrate. The light coating may cover the original color of the substrate, however some of the original color may show through. The merged layer of the first coat of resin and the epoxy layer acts as a barrier to the substrate being a heat sink. This enables further coatings to be melted quicker.

The merged layer (epoxy/resin) should be allowed to fully cure. Once fully cured, a second coat of resin is applied (thermal sprayed) using the thermal sprayer 230. For this pass the substrate should be completely covered. Prior to applying (thermal spraying) the second coat you want to heat the surface until the previously applied first coat of resin starts to turn glossy. Accordingly, as you are applying the second coat you may have to alternate between simply heating the surface with the flame and spraying the resin. Once the second coat of resin has been applied to a current section of the substrate you may want to heat the resin until it starts to turn glossy for a next section. You continue to do sections of the substrate until the entire substrate has been covered with the second coat. According to one embodiment, the second coat should be the same color (or color mix) as the first coat. The substrate should now be completely covered with the defined color associated with the resin. If required certain sections may be reheated to melt out the resin so that it obtains the desired glossy finish.

When using the thermal sprayer to apply the resin there are thermal sprayer parameters (e.g., sprayer air, material flow rate, flame heat) and operator parameters (e.g., pass speed, spray distance) to consider. Sprayer air is the amount of air used to transport the resin through the flame and onto the surface. The sprayer air also shields the resin powder as it flows through the flame. Too little sprayer air may result in the resin burning as it passes through the flame while too much sprayer air may result in cooling the resin as you are trying to heat it. Material feed rate is the speed at which the material is fed through the flame and onto the surface. A faster rate will enable more resin to be applied but too fast of a rate may cause a build-up of resin. A slow rate may result in the resin not coating the surface and cause you to have to re-spray an area and thus work slower. Flame heat is the heat used to melt the resin powder. Too much heat may result in burning the powder and also using excess fuel. Too little heat and the powder may not process (e.g., melt) appropriately. As noted above, the resin is designed to melt at, or slightly below, approximately 120° C.

Pass speed is the speed at which an individual applying the resin moves the thermal sprayer over the surface. If the speed is too fast, not enough resin will be applied to the surface while if the speed is too slow resin build-up may occur. Spray distance is the distance the thermal sprayer is away from the surface. Spraying from farther away will cover a larger area with less material. Spraying too far away may result in an inaccurate spray as gravity, wind, or the like may affect the spray pattern. Spraying closer will cover a smaller area with more material. Spray distance may also affect the temperature which may affect the resin. Spraying too close my result in burning the resin while spraying too far may enable the resin to cool prior to application to the surface.

According to one embodiment, it may be desirable to utilize more than a single color (or color mix) on the substrate. The use of multiple colors may be for aesthetics or may be to serve some type of purpose. For example, some substrates (e.g., pilings) may desire to utilize multiple colors to identify, for example, depth (e.g., different colors representing different depths). A boat may look better if it has multiple colors or patterns. Different colors may be utilized to provide words and/or symbols in the substate to identify different parameters (e.g., warnings, information). Layering techniques can be utilized to provide patterns, markings, or the like by applying resins having different colors (or color mixes) on top of the first color of resin after the first color of resin has dried.

FIG. 3 illustrates a block diagram of an exemplary layering method to create a multi-colored substrate 300. The process starts after the initial first color of resin has been applied 200. In order to create the pattern or the markings, a portion of the substrate (having first color mix of resin) may be masked 310. The masking may utilize tape or stencils to create the desired pattern or markings. The tape and/or stencils utilized may be silicon coated. The tape and/or stencils utilized may be made from the type of material that is utilized to secure items to glass. The areas around the patterns created that you do not want to be coated with the second color mix of resin may be covered. After the pattern has been formed and the surrounding areas covered, a coat of a second color (or color mixture) of resin is applied (thermal sprayed) to the desired areas 320. This coat of resin is applied in a similar manner to the other coats of resin.

Once the second color of resin has cooled sufficiently, the masking is removed 330. Care should be taken to not remove the masking too early or the resin may stick thereto and be pulled off the substrate. When the masking is taken off some of the adhesive may be left behind on the substrate. The adhesive may be removed using a solvent such as Goo Gone or Acetone. Once the masking has been removed, the two-color schemes of resin may be blended by heating the border between the two-color schemes using the thermal sprayer (or a heat gun). The heating of the border melts the two colors and helps eliminate any hard lines between the colors. Care should be taken not to overheat the resin because it may cause the first color scheme (lower layer) to bleed through the second color scheme (upper layer) or may burn the resin.

If additional colors or markings are desired or required, the process may be repeated any number of times for the additional color(s). The various colors used to create the patterns, markings or the like are not limited to any specific colors. The colors may be selected based on any number of parameters. According to one embodiment, it may be desirable to have the initial layers be lighter than the layers added thereon for easier coverage and less bleeding through. That is, putting a lighter color on top of a darker color may result in bleeding of the darker color through the lighter color.

According to one embodiment, the resin may be modified to provide antifouling properties to help prevent the biofouling of the substrate. The antifouling resin would present its antifouling properties immediately upon application and would not require gradual degradation to expose the active antifouling agent as is required with conventional antifouling strategies utilizing coatings containing cuprous oxide. The resin may have an antimicrobial (e.g., silver) and/or an antifungal (e.g., copper) embedded and integrated with the coating prior to application.

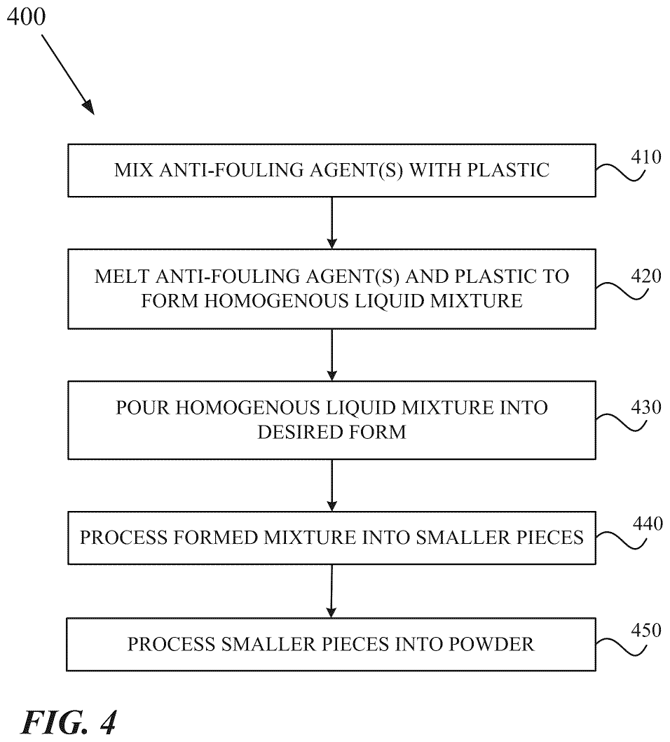

FIG. 4 illustrates an exemplary process for creating an antifouling coating to prevent marine growth on underwater structures 400. Initially, an agent that prevents, or limits, biofouling (an antifouling agent) is mixed with plastic (e.g., polyethylene plastic) in a controlled facility (e.g., container) 410. The antifouling properties may be provided by an antifungal agent (e.g., copper) or an antimicrobial agent (e.g., silver). The antifouling agent may be a single agent (e.g., an antifungal agent; an antimicrobial agent) or may be a combination of agents (e.g., an antifungal agent and an antimicrobial agent; multiple antifungal agents, multiple antimicrobial agents). The exact ratio of the antifouling agent(s) and the plastic may vary depending on different factors. According to one embodiment, the amount of antifouling agent(s) will be between approximately 5-20% of the amount of plastic. It should be noted that at this point the antifouling agent(s) and the plastic while mixed together are still separate components. The container is then heated in order to melt the antifouling agent(s) and plastic so that they are amalgamated and form a homogenous liquid mixture 420. The liquid is then poured/extruded into a desired form (e.g., coils, rods) and allowed to harden to create a formed mixture 430. The desired form is not limited to any specific shape or size but rather can be any form that can easily be processed (e.g., cut, ground).

The formed mixture is then processed (e.g., cut, ground) into pellets 440. The process for creating the pellets could be any known process for reducing the formed mixture into pellets of a defined size without departing from the scope of the current invention. The pellets may then be processed (e.g., crushed, ground) into a powder (antifouling resin) 450. Various different processes, or machines, may be used to create the powder without departing from the scope of the current invention.

It should be noted that the method 400 is in no way intended to be limited to the exact steps and sequence described above. Rather, steps may be added, removed, combined split apart, and/or rearranged with departing from the current scope. Furthermore, different materials or combinations of materials providing antifouling properties could be utilized without departing from the current scope.

The antifouling resin may be applied to the substrate according to the process 200 defined with respect to FIG. 2. The first coat 220 and the second coat 230 may both use the antifouling resin or the first coat 220 may be a standard resin and the second coat 230 may be the antifouling resin. Flame spraying of the antifouling resin ensures that the antifouling agent(s) is evenly distributed and readily available on the surface of the substrate. Unlike traditional coatings that require gradual degradation to expose the active antifouling agent, this antifouling agent-polyethylene composite immediately presents its antifouling properties upon application.

If patterns, markings, or the like are to be applied to the substrate, additional antifouling resin may be applied to the previously coated substrate according to the process 300 defined with respect to FIG. 3. If the additional antifouling resin is to be provided over a substantial portion of the previously coated substrate, the initial coating may simply be resin as the anti-fowling properties will be provided by the additional antifouling layer (e.g., having a second color). For example, if the bottom half of the boat is coated a first color and then the portion of the bottom of the boat that is typically in the water is coated a second color the first color may be provided by a standard resin while the second color may be provided by an anti-fowling resin. The application of a standard resin on top of an anti-fowling resin is not advised as it would lock the anti-fowling properties in and diminish, if not destroy, the anti-fowling properties.

The use of the antifouling resin not only enhances the effectiveness of the antifouling process but also significantly reduces the release of potentially harmful chemicals into the ocean. This environmentally considerate approach aligns with the increasing need for sustainable practices in marine applications, effectively reducing the impact on the natural oceanic ecosystem while efficiently preventing biofouling.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A method for preparing an antifouling resin to combat bio-fouling, the method comprising:
mixing an antifouling agent with a plastic in a container;
heating the container to an appropriate temperature so that the antifouling agent and the plastic are melted and amalgamated to form a homogenous liquid mixture;
pouring the homogenous liquid mixture into a desired form and allowing the mixture to harden to create a formed mixture;
processing the formed mixture into a plurality of smaller sized pieces; and
processing the smaller sized pieces into a powder, wherein the powder is an antifouling agent infused resin.

2. The method of claim 1, wherein the antifouling agent is an antimicrobial agent.

3. The method of claim 2, wherein the antimicrobial agent is copper.

4. The method of claim 1, wherein the antifouling agent is an antifungal agent.

5. The method of claim 4, wherein the antifungal agent is silver.

6. The method of claim 1, wherein the plastic is a polyethylene plastic.

7. The method of claim 1, wherein the formed mixture is a spiral or a rod.

8. The method of claim 1, further comprising applying the antifouling resin to an underwater structure.

9. The method of claim 8, wherein the applying the antifouling resin includes
applying an epoxy layer to the underwater structure;
thermal spraying a first coat of the antifouling resin while the epoxy is tacky, wherein the epoxy layer and the first coat of antifouling resin merge into a single layer;
allowing the single layer to cure; and
thermal spraying a second coat of the antifouling resin on the cured single layer.

10. The method of claim 8, further comprising preparing the underwater structure prior to applying the antifouling resin.

11. The method of claim 8, further comprising patterning the underwater structure by applying at least one additional layer of antifouling resin having a different color on top of the antifouling resin applied to the underwater structure.

12. A method for applying a resin to an underwater structure to combat bio-fouling, the method comprising:
preparing the underwater structure;
applying an epoxy layer to the underwater structure;
thermal spraying a first coat of the resin while the epoxy is tacky, wherein the epoxy layer and the first coat of resin merge into a single layer;
allowing the single layer to cure; and
thermal spraying a second coat of the resin on the cured single layer.

13. The method of claim 12, wherein preparing the underwater structure includes at least some subset of cleaning the surface of loose materials and surface contamination, repairing any defects, applying an epoxy layer to the underwater structure to fill any voids and profiling a surface of the underwater structure to provide a rough texture for better adhesion of the epoxy.

14. The method of claim 12, further comprising patterning the underwater structure by thermal spraying at least one additional layer of resin having a different color on top of the second coat of the resin.

15. The method of claim 14, wherein the patterning includes
masking a portion of the underwater structure;
thermal spraying that at least one additional layer of resin having a different color on unmasked portions of the underwater structure;
removing the masking; and
thermal spraying dividing lines between two colors of resin to blend.

16. The method of claim 12, wherein the resin is an antifouling resin.

17. The method of claim 16, wherein the antifouling resin includes at least some combination of an antimicrobial agent and an antifungal agent.

18. The method of claim 16, further comprising preparing the antifouling resin by:
mixing an antifouling agent with a plastic in a container;
heating the container to an appropriate temperature so that the antifouling agent and the plastic are melted and amalgamated to form a homogenous liquid mixture;
pouring the homogenous liquid mixture into a desired form and allowing the mixture to harden to create a formed mixture;
processing the formed mixture into a plurality of smaller sized pieces; and
processing the smaller sized pieces into a powder, wherein the powder is an antifouling agent infused resin.

19. A method for applying an antifouling resin to an underwater structure to combat bio-fouling, the method comprising:
obtaining the antifouling resin;
preparing the underwater structure;
applying an epoxy layer to the underwater structure;
thermal spraying a first coat of the antifouling resin while the epoxy is tacky, wherein the epoxy layer and the first coat of the antifouling resin merge into a single layer;
allowing the single layer to cure; and
thermal spraying a second coat of the antifouling resin on the cured single layer.

20. The method of claim 19, wherein the obtaining the antifouling resin includes:
mixing an antifouling agent with a plastic in a container;
heating the container to an appropriate temperature so that the antifouling agent and the plastic are melted and amalgamated to form a homogenous liquid mixture;
pouring the homogenous liquid mixture into a desired form and allowing the mixture to harden to create a formed mixture;
processing the formed mixture into a plurality of smaller sized pieces; and
processing the smaller sized pieces into a powder, wherein the powder is the antifouling resin.
